(19) United States
(12) Patent Application Publication
(10) Pub. No.: US 2022/0414362 A1
(43) Pub. Date: Dec. 29, 2022

(54) METHOD AND SYSTEM FOR OPTIMIZING IMAGE DATA FOR GENERATING ORTHORECTIFIED IMAGE

(71) Applicant: Sharper Shape Oy, Espoo (FI)

(72) Inventors: Jyri Lautala, Helsinki (FI); Rami Piiroinen, Espoo (FI)

(73) Assignee: Sharper Shape Oy, Espoo (FI)

(21) Appl. No.: 17/360,568

(22) Filed: Jun. 28, 2021

(51) Int. Cl. G06K 9/00; B64C 39/02; G06T 1/20; G06T 1/60; G01S 17/89; G06T 7/62

(52) U.S. Cl. CPC G06K 9/0063; B64C 39/024; G06T 1/20; G06T 1/60; G01S 17/89; G06T 7/62; B64C 2201/127; G06K 2009/00644; B64C 2201/146

(57) ABSTRACT

A method for optimizing image data for generating orthorectified image(s) related to an area of interest in an environment. The method includes receiving a first image dataset of the area of interest captured therein, identifying each of multiple objects in the area of interest, receiving attribute information related to each of the multiple identified objects, determining if one or more of the multiple identified objects satisfy at least one of a risk criteria based on the attribute information therefor, identifying a maximum relevant second area including at least the area of interest and each of the one or more of the multiple identified objects satisfying the at least one of risk criteria, and processing the first image dataset to either discard or down-sample areas other than the maximum relevant second area captured therein.

### TECHNICAL FIELD

The present disclosure relates to orthorectification of image data; and more specifically to systems and methods for optimizing image data for generating orthorectified image(s) related to an area of interest in an environment.

### BACKGROUND

In recent times, the implementation of high resolution satellite imaging technology to provide a rich source of up-to-date, large scale, geospatial earth-observation data has increased exponentially. Such high resolution images (such as hyperspectral images) have already confirmed their usability in many mapping-oriented application areas. Generally, taking into account the fine spatial resolution of hyperspectral images and their information content, it can be noted that the planimetric accuracy of the delivered raw image, in comparison to ground sampling distance (GSD) (or pixel size) is relatively poor, due to a number of geometric distortions. The inherent geometric accuracy of the captured images and their approximate georeferencing needs to be improved by applying 3D geometric rectification (or orthorectification).

However, orthorectification of high resolution images require highly accurate ancillary data due to the sensor (image) parameters, acquisition conditions, and potentially achievable target planimetric accuracy. Notably, the significant (in relation to image GSD) level of distortion and especially relief displacement demands usage of orthorectification (or 3D correction) methods, unlike the conventional 2-D correction methods. Typically, orthorectification involves converting images into actual map-like (metric quality) form by accurately removing associated satellite, scanner (camera), and terrain related distortions. The resulting orthorectified image may then be directly applied in mapping oriented area applications e.g., terrain analysis, thematic information extraction, area measurements, etc.

Typically to perform such a function of orthorectification, an accurate description of the sensor, typically called the sensor model, detailed information about the sensor location and orientation for each captured frame and an accurate terrain model (such as, the World Elevation service available from ArcGIS Online) is required. These constraints have implications on the choice of image data type and the processing level or capability, memory of the processing device or system.

In an exemplary scenario, for orthorectification of image data, at least two imaging methods are needed i.e., the digital elevation model (DEM) to observe and monitor the height/elevation of multiple objects in the images. Generally, the imaging process is typically done with an aerial vehicle or drone, which obviously creates issues due to varying tilt of the sensors as the aerial vehicle can rotate in 3D during the flight. Thus, every pixel of the captured image needs to be associated with metadata comprising (sensor) boresight and 3D position and orientation provided by associated IMU (Inertial Measurement Unit) and GNSS (Global Navigation Satellite System). Upon associating each pixel with the metadata, the captured pixels of the image data are orthorectified and mapped to an actual 3D location on a given map projection. The resulting hyperspectral image can thereafter be used to identify e.g. tree species which may pose a threat to infrastructure, such as powerlines, railway lines, gas pipes and so forth. For example, tops of the trees for each geolocation can be analysed using hyperspectral imaging (HSI), typically with a line sensor providing the data pixel by pixel, each pixel comprising a sampled measurement of incoming light spectrum.

Orthorectification is a mandatory pre-processing step in hyperspectral processing, but the challenge is that it is a data intensive, time-consuming and very expensive task. Generally, full-captures of powerline grids may consume up to petabyte(s) of data. To address the aforementioned problem, conventional solutions require manual use of an UI, and focus on processing one dataset at a time. To handle the petabytes of data cloud solutions are needed. Since, the HSI data needs to be stored in a format that provides ease of use and a single capture may be over a terabyte of data, hence the orthorectified output data needs to be cut into manageable tiles for parallel processing. Moreover, there is a need to reduce the amount of computer memory used, and the time to orthorectify the captured HSI data.

Therefore, in light of the foregoing discussion, there exists a need to overcome the aforementioned drawbacks and provide an improved system or method for optimizing image data for generating orthorectified image(s)

### SUMMARY

The present disclosure seeks to provide a method and a system for optimizing image data for generating orthorectified image(s) related to an area of interest in an environment. An aim of the present disclosure is to provide a solution that overcomes at least partially the problems encountered in prior art.

In one aspect, an embodiment of the present disclosure provides a method for optimizing image data for generating orthorectified image(s) related to an area of interest in an environment, the method comprising:

receiving a first image dataset of the area of interest captured therein;

identifying each of multiple objects in the area of interest from the first image dataset;

receiving attribute information related to each of the multiple identified objects;

determining if one or more of the multiple identified objects satisfy at least one of a risk criteria based on the attribute information therefore, wherein the risk criteria comprises at least one of selected from: a risk of infiltrating or having potential risk to infiltrate into the area of interest, a risk of posing a hazard to the area of interest;

identifying a maximum relevant second area comprising at least of the area of interest and each of the one or more of the multiple identified objects satisfying the at least one of risk criteria; and

processing the first image dataset to either discard or down-sample areas other than the maximum relevant second area captured therein, to obtain a second image dataset for performing orthorectification.

In another aspect, an embodiment of the present disclosure provides a system for optimizing image data for generating orthorectified image(s) related to an area of interest in an environment, the system comprising a data processing arrangement, wherein the data processing arrangement is configured to:

receive a first image dataset of the area of interest captured therein;

identify each of multiple objects in the area of interest from the first image dataset;

receive attribute information related to each of the multiple identified objects;

determine if one or more of the multiple identified objects satisfy at least one of a risk criteria based on the attribute information therefore, wherein the risk criteria comprises at least one of selected from: a risk of infiltrating or having potential risk to infiltrate into the area of interest, a risk of posing a hazard to the area of interest;

identify a maximum relevant second area comprising at least the area of interest and each of the one or more of the multiple identified objects satisfying the at least one of risk criteria; and

process the first image dataset to either discard or down-sample areas other than the maximum relevant second area captured therein, to obtain a second image dataset for performing orthorectification.

Embodiments of the present disclosure substantially eliminate or at least partially address the aforementioned problems in the prior art, by selectively reducing the size of the image dataset to be orthorectified, thereby facilitating faster and less computation-intensive orthorectification.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a flowchart of a method for optimizing image data for generating orthorectified image(s) related to an area of interest in an environment, in accordance with an embodiment of the present disclosure;

FIG. 2 is a block diagram of a system for optimizing image data for generating orthorectified image(s) related to an area of interest in an environment, in accordance with an embodiment of the present disclosure;

FIG. 3 is a diagrammatic illustration of an exemplary working environment of an aerial vehicle for capturing image data for generating orthorectified image(s) related to an area of interest in an environment, in accordance with an embodiment of the present disclosure;

FIG. 4 is a diagrammatic illustration of an exemplary working environment including a power distribution infrastructure, in accordance with an embodiment of the present disclosure; and

FIG. 5 is a diagrammatic illustration of an exemplary environment including a power distribution infrastructure and a tree, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In an aspect, an embodiment of the present disclosure provides a method for optimizing image data for generating orthorectified image(s) related to an area of interest in an environment, the method comprising:

receiving a first image dataset of the area of interest captured therein;

identifying each of multiple objects in the area of interest from the first image dataset;

receiving attribute information related to each of the multiple identified objects;

determining if one or more of the multiple identified objects satisfy at least one of a risk criteria based on the attribute information therefor, wherein the risk criteria comprises at least one of selected from: a risk of infiltrating or having potential risk to infiltrate into the area of interest, a risk of posing a hazard to the area of interest;

identifying a maximum relevant second area comprising at least the area of interest and each of the one or more of the multiple identified objects satisfying the at least one of risk criteria; and

processing the first image dataset to either discard or down-sample areas other than the maximum relevant second area captured therein, to obtain a second image dataset for performing orthorectification.

In another aspect, an embodiment of the present disclosure provides a system for optimizing image data for generating orthorectified image(s) related to an area of interest in an environment, the system comprising a data processing arrangement, wherein the data processing arrangement is configured to:

receive a first image dataset of the area of interest captured therein;

identify each of multiple objects in the area of interest from the first image dataset;

receive attribute information related to each of the multiple identified objects;

determine if one or more of the multiple identified objects satisfy at least one of a risk criteria based on the attribute information therefor, wherein the risk criteria comprises at least one of selected from: a risk of infiltrating or having potential risk to infiltrate into the area of interest, a risk of posing a hazard to the area of interest;

identify a maximum relevant second area comprising at least the area of interest and each of the one or more of the multiple identified objects satisfying the at least one of risk criteria; and

process the first image dataset to either discard or down-sample areas other than the maximum relevant second area captured therein, to obtain a second image dataset for performing orthorectification.

The present disclosure provides a method for optimizing image data for generating orthorectified image(s) related to an area of interest in an environment. Generally, existing raw aerial imagery captured by aerial vehicles (such as satellites, aeroplanes, helicopters, drones, etc.) contains distortions (or image distortions) induced due to several reasons including, but not limited to, sensor orientation, topographical variation, curvature of the earth and so forth. During data collection of satellite imagery, the raw data needs to be processed in order to correct the associated inaccuracies, using orthorectification methods. The term “orthorectified image” refers to a corrected image based on at least the topographical variations and sensor orientation. Generally, the orthorectified image is a correctly identified and/or located image, wherein the pixels of the image to be orthorectified using the method are rearranged (or relocated) to accurately place the displaced pixels to their correct position. However, orthorectification of image data is a computationally expensive and time-consuming task and performing orthorectification on captured raw satellite data having a very large size (for example, 500 Terabytes) requires a lot of time and resources. In light of the need, the aforesaid method optimizes the image data for generating the orthorectified images, in which the optimization can be beneficially performed in a variety of ways such as, but not limited to, data splitting, data removal or discarding, data down-sampling, data resizing, data compression and so forth described further in detail in the present disclosure.

The term “area of interest” refers to a preferred area or an area under observation in an environment based on the need of the implementation. For example, the environment may be a large area such as one or more villages, towns, cities, states, or countries, wherein the area of interest may be one or more powerlines, railway tracks, gas pipelines in the environment. Typically, the area of interest comprises a focal point (such as a powerline or gas pipeline) being observed and managed based on the implementation to protect from nearby surroundings, such as the nearby objects (such as trees, buildings, rocks etc.). In an exemplary scenario, for maintenance and repair purposes of powerline grid, the environment such as a ‘Region A’ comprising the area of interest (or focal point) i.e., the area encompassed by the powerline and the multiple objects in vicinity are observed and monitored to keep track of the powerline such as, growth of nearby trees in order to ensure that the nearby objects do not obstruct or cause any risk during operation of the powerline. Typically, the image data captured during a one hour flight (partial-capture) from a drone may result up to terabyte(s) of data, whereas a complete capture of the entire powerline grid may take up to petabyte(s) of data and hence causes a significant problem during processing and storage of the captured image data. Thus, to overcome said problem, the method is employed to optimize the image data for generating the orthorectified image(s) related to the area of interest (such as, the powerlines) in the environment to effectively reduce the size of image data to be processed for further orthorectification, and to reduce the computational time and associated resources significantly to make the orthorectification faster and efficient.

In general, the image data comprises at least one of the list of timestamps, locations, and orientations for each image taken by the aerial vehicle during a given time range for capturing the image data. Notably, the image data is orthorectified using the method and mapped to actual mapped locations in the form of a data representation, such as raster file that comprises of each hyperspectral band orthorectified to specified coordinate system.

Throughout the present disclosure, the term “aerial vehicle” refers to an unmanned or manned aerial vehicle operatively coupled to the data processing arrangement for capturing image data for generating orthorectified image(s). The aerial vehicle may be a drone (such as small drone, rotor drone, fixed wing drone, a quadcopter, a reconnaissance drone and the like). Optionally, the aerial vehicle may be an unmanned aerial vehicle (UAV) such as a drone fixed wing aircraft, a rotary wing aircraft and the like or a manned aerial vehicle implemented as a helicopter, a quatrocopter, an octocopter, and the like. Optionally, the aerial vehicle may be a space-borne vehicle such as a satellite, rocket etc. Optionally, the aerial vehicle is implemented as a multi single rotor helicopter, multi-rotor helicopter and the like. It may be understood that the aerial vehicle may be either an unmanned or a manned aerial vehicle depending upon the implementation without limiting the scope of this disclosure.

Furthermore, the aerial vehicle is configured to perform three-dimensional movements for capturing the image data from different angles and orientations with respect to the area of interest to enable the system to track or monitor the environment. Notably, the aerial vehicle is enabled with at least one imaging device for capturing hyperspectral images and/or high-resolution images, a microphone and a speaker for collecting and/or transmitting audio-visual information pertinent to the area of interest and a sensor arrangement for managing flight of the aerial vehicle. For example, the sensor arrangement includes a group of sensors including, but not limited to, a gyroscope, Micro-Electromechanical Systems (MEMS), accelerometer, acoustic sensor, light sensor, pressure sensor, smoke sensor, heat sensor, proximity sensor and the like. Optionally, the sensor arrangement is operable to generate operational data for the aerial vehicle to be operated via a controller. The operational data includes sensed information from the sensor arrangement to enable the aerial vehicle to manage flight while capturing image data. The controller includes a combination of hardware and software components. For example, the controller may include a processor, memory and input/output peripherals and software to be executable by the processor and stored in the memory. In operation, the controller is operable to receive instructions from the user device in the form of control signals. The term ‘control signal’ refers to a pulse or frequency of electricity or light that carries data for a control command as it travels over a network, a computer channel or wireless. Typically, the control signal comprises data related to the trajectory or path to be followed by the aerial vehicle to capture the first image dataset related to the area of interest in the environment based on the method.

In an embodiment, the image data comprises at least one of selected from: Light Detection and Ranging (LiDAR) data, hyperspectral imaging (HSI) data, Global Navigation System Satellite (GNSS) data, Inertial Measurement Unit (IMU) data. The term “LiDAR data” refers to a collection of data captured by a LiDAR unit. Optionally, the LiDAR unit (for example, such as a LiDAR laser scanner) is mounted on an aerial vehicle that is employed for capturing a given LiDAR dataset of the environment. Optionally, the given LiDAR dataset comprises a plurality of data points. Optionally, when the given unmanned or manned aerial vehicle is implemented as the helicopter, a large volume of data points are generated in the given LiDAR dataset. The plurality of data points represent objects (such as, buildings, vegetation, and the like) on and above a ground surface in a three-dimensional space of the environment. Optionally, location of a given data point is expressed as (x, y, z) coordinates along X, Y, and Z axes, respectively of a given coordinate system employed for the environment. Optionally, the plurality of data points is collectively referred to as point clouds.

Herein, the term “hyperspectral data” refers to a spatially sampled dataset comprising a plurality of pixels related to hyperspectral images captured or collected by hyperspectral imaging devices across the electromagnetic spectrum. Typically, each pixel in the hyperspectral data or image corresponds to a spectral band in the electromagnetic spectrum. The term “spectral band” refers to a matrix of points defined by three dimensions, its coordinates and the intensity relating to the multiple spectral bands of the hyperspectral image. Generally, the hyperspectral data comprises of narrow spectral bands in the order of 5-20 nanometres (nm) and number of spectral bands range in from tens to hundreds of spectral bands. In the present implementations, the hyperspectral data may range from 350 nm to 13000 nm, and preferably from 400 nm to 1700 nm. For example, the hyperspectral data may be 400 nm, 600 nm, 800 nm, 1000 nm, 1200 nm, 1400 nm or 1600 nm up to 600 nm, 800 nm, 1000 nm, 1200 nm, 1400 nm, 1600 nm or 1700 nm. The term “hyperspectral imaging or HSI” refers to a type of spectral imaging for inferring spectral characteristics of an image, wherein the spectra is divided to N different wavelengths. Notably, the sampling of the hyperspectral data may or may not be spatially regular based on the implementation. However, the irregular spatial sampling of the HSI data used herein may be orthorectified, i.e., normalized in a given plane, such as the x-y plane.

Optionally, each pixel in a given hyperspectral image represents a 20 cm×20 cm area within the environment. However, the resolution may be configured to be changed based on the implementation. For example, each pixel may cover a 5 cm×5 cm area, 10 cm×10 cm area, 50 cm×50 cm area, 1 m×1 m area and so forth. Generally, the hyperspectral images are processed to obtain the spectrum for each pixel in the hyperspectral image. For example, the hyperspectral image of an environment to find, distinguish and identify objects and materials and/or detecting processes. It will be appreciated that a geographical area represented by a given pixel in a given LiDAR data or HSI data subset may lie in a range of 0.01 square meters to 1000000 square metres. For example, the geographical area represented by a given LiDAR data or HSI data subset may be from 0.01, 1, 100, 1000, 10000 square metres upto 100, 1000, 10000 or 1000000 square metres. It will be appreciated that the given LiDAR data or HSI data is divided into the plurality of LiDAR data or HSI data subsets having a plurality of geographical areas. In an example, there may be a given LiDAR data for a total geographical area of 4000 square metres. The given LiDAR dataset may be divided into four LiDAR subsets A1, A2, A3 and A4 corresponding to geographical areas of 1000 square meters each. Beneficially, each of the subsets of the LiDAR or HSI data may be captured with a variable resolution depending upon the level of detail or clarity required i.e., in contrast to or inversely proportional to the size of the dataset. For example, subsets A1 and A2 may represent LIDAR data for areas that are near a power line, and may therefore, be processed in a resolution as high as 0.01 square metres per pixel. On the other hand, subsets A3 and A4 may represent LIDAR data for areas that are far away from the power line, and may therefore, be processed in a resolution as low as 250 square metres per pixel.

Further, as used herein, the term “GNSS data” refers to Global Navigation Satellite System (GNSS) i.e., a constellation of satellites providing positioning and timing data to GNSS receivers. The term “IMU data” refers to Inertial Measurement Unit (IMU) data i.e., a collection of measurement tools including a plurality of parameters for tracking or locating an object (stationary or moving) in the environment. The IMU unit comprises a plurality of sensors for tracking objects, including accelerometers, gyroscopes, magnetometers and the like to provide the IMU data. For example, the parameters include, but is not limited to, location, height, roll, pitch, yaw, and timing. Optionally, other type of sensors, for measuring/monitoring other parameters may be used for e.g., sensors to monitor exposure levels, sun brightness, weather data, humidity, wind speed, etc.

The method comprises receiving a first image dataset of the area of interest captured therein. Generally, the first image dataset is received from a data source and comprises the area of interest captured therein. The “data source” refers to any source of data providing the first image dataset. For example, the data source may be a database, a flat file, live measurements from physical imaging devices, scraped web data, or any of the myriad static and streaming data services on the internet. Typically, the first image dataset is obtained by imaging via at least one imaging device of the aerial vehicle (such as, airborne or satellite sensors and/or drones comprising the at least one imaging device) on a target area i.e., the area of interest. Additionally, the first image dataset may be received directly from a local or remote system and/or database comprising the first image dataset or the image data. In an example, the data source is a drone or unmanned aerial vehicle (UAV) configured with a LiDAR and/or HSI device to capture and transmit the first image dataset. In another example, the data source is a proprietary database comprising image data including hyperspectral data, LiDAR data, GNSS data and IMU data.

Pursuant to embodiments, the first image dataset is processed to remove the unwanted captured areas (i.e., not included in the area of interest) in the environment, thereby obtaining the second image dataset. This reduces the size of the image dataset and enable faster orthorectification processing. It will be appreciated that the process of capturing the first image dataset including the LiDAR data, the HSI data, the GNSS data and the IMU data is a highly time-consuming task requiring several days or weeks depending upon the total geographical area of the environment for which the image data is to be captured. Thus, identifying, from the first image dataset, the second image dataset that is related only to the area of interest in the environment reduces the overall size of the image data and consequently reduces the amount of data required to be orthorectified, at least to some extent.

The method comprises identifying each of multiple objects in the area of interest from the first image dataset. Generally, the area of interest comprises multiple objects such as, trees, buildings, structures and so forth that are needed to be identified to effectively monitor the area of interest. In an exemplary scenario, the monitoring of powerlines (or the area of interest) over a geographical area (or the environment) (for example, 500 m×500 m) comprises a plurality of objects (for example, 1010 objects including 1000 trees and 10 buildings). However, the area of interest includes only the objects located near the vicinity of the powerline, i.e., as per the example, the area of interest may include only 102 objects (for example, including 100 trees and 2 buildings).

Thus, the second image dataset optionally comprises the image data captured based on the area of interest comprising only the 102 objects out of the 1010 objects in the environment and does not include the areas other than the area of interest i.e., not in the vicinity of the powerline (remaining 908 objects). Alternatively, the second image dataset comprises only the downsampled data pertaining to the areas other than the area of interest.

Herein, for effective monitoring of the powerline, the method comprises identifying the multiple objects in the area of interest from the first image dataset. Typically, the multiple objects are identified using a detection and/or identification algorithm that may or may not be assisted by a human expert or user. Herein, the detection and/or identification algorithm is a machine learning algorithm configured to identify the multiple objects based on the information provided from the capture image data or the first image dataset. Typically, the method comprises using the first image data comprising the LiDAR data, the HSI data, the GNSS data and/or the IMU data to identify the multiple objects in the area of interest. For example, while using hyperspectral image (HSI) data, the spectrum for each pixel in the hyperspectral image data is identified and compared with existing data or with the help of a human expert to accurately identify find, distinguish, and identify objects, materials and/or detecting processes in the area of interest.

In an embodiment, the method further comprises generating the first image dataset, wherein generating the first image dataset comprises obtaining one or more parameters to be followed by an aerial vehicle, wherein the one or more parameters comprise at least a path and a speed for the aerial vehicle. Typically, while generating the first image dataset using the aerial vehicle, the one or more parameters are defined to be followed by the aerial vehicle to effectively capture the first image dataset. The parameters include at least the path and the speed, however other parameters such as orientation information, air-traffic information, weather information, lighting information and so forth may also be provided to the aerial vehicle. These parameters allow the aerial vehicle to effectively capture the first image dataset comprising the area of interest and enable the aerial vehicle to minimize or eliminate the unusable or unwanted captured data.

In this regard, the generation of the first image data further comprises controlling the aerial vehicle according to the one or more parameters to capture the said image dataset and discarding a subset of the captured image dataset corresponding to failure of the aerial vehicle to follow the parameters therefor. Typically, the aerial vehicle is configured to follow these parameters. For example, the aerial vehicle follows a defined path or route at defined speeds at particular orientation or distance from the area of interest to capturing the first image dataset. Herein, for first flight information of the aerial vehicle, conventional mapping or satellite systems may be employed such as, the United States Geological Survey (USGS) National Map in the United States. However, if the aerial vehicle fails to follow the parameters and consequently the subset of the captured image dataset comprising a lower quality image is also captured, the subset of the first image dataset is discarded from the first image dataset to eliminate the unnecessary image data and reduce the computational time and effort during orthorectification and/or processing and thus making the method faster and efficient.

In an embodiment, generating the first image dataset further comprises controlling an aerial vehicle to capture an image dataset of the area of interest, identifying at least two subsets of the captured image dataset having an overlapped area of the area of interest captured in each of the at least two subsets. Upon capturing the image dataset, the method comprises identifying the at least two subsets of the image dataset having the overlapped area of interest. Further, the generation of the first image dataset comprises selecting one of the at least two subsets for capturing the said overlapped area of the area of interest based on a selection criteria, wherein the selection criteria comprises at least one of selected from: speeds of the aerial vehicle while capturing the at least two subsets, orientations of the aerial vehicle while capturing the at least two subsets, lighting conditions while capturing the at least two subsets. In some cases, while capturing image data along the area of interest, different orientations and angles of the aerial vehicle cause overlapping of the captured images in the image dataset. In other words, the aerial vehicle tends to capture at least two image datasets of the same object, location and/or overlapped area. Thus, to eliminate unnecessary repetitions of the similar images data from the image dataset, the method comprises selecting one of the at least two subsets of the capture image dataset based on the selection criteria. Typically, the at least two subsets are compared to select one of the at least two subsets having better attributes and/or conditions while capturing the image dataset, wherein the comparison is based on at least one of the speeds of the aerial vehicle, the orientations of the aerial vehicle, the lighting conditions, weather conditions and so forth. Optionally, if there are at least two images that capture a same sub-area in the area of interest, brightness levels of respective pixels of the at least two images are compared, and a pixel having a higher brightness level is selected. Thus, beneficially, the method comprises processing only one of the at least two subsets i.e., only the areas that have the best capture conditions, and discards the other subset to reduce the associated data storage, data storage costs, data transfer delays and computation time.

Optionally, in this regard, the method further comprises identifying the at least two subsets based on same geo-coordinates corresponding to capturing of the at least two subsets. Typically, the method comprises identifying the at least two subsets based on the same geo-coordinates. Herein, each of the captured subsets of the capture image data or the first image dataset is compared with respect to one another based on the geo-location of the capture images provided by the GNSS data, IMU data (in the image data) to identify the at least two subsets having the same geo-coordinates. The identified at least two subsets may then be selected based on the selection criteria to select a subset having better attributes and/or conditions similar to the at least two subsets based on the overlapped area from the area of interest. Beneficially, by identifying the at least two subsets based on the sub-substantially same geo-coordinates, the better quality image of the at least two subsets may be selected based on the selection criteria and the lower quality image shall be discarded to reduce the overall size of the dataset to be orthorectified. Further, the reduction in the overall size of the dataset results in reduced memory storage, memory storage costs, associated computation time and power consumption. As a result of the reduced computation time, the reduced memory and power consumption, the present method provides faster and efficient generation of orthorectified image(s).

In an embodiment, generating the first image dataset further comprises pre-identifying one or more non-interesting areas of the environment for generating orthorectified image(s) and capturing relatively lower resolution images of the one or more pre-identified non-interesting areas as compared to the area of interest while capturing a plurality of images of the area of interest. Based on the implementation, the area of interest changes and thus the corresponding non-interesting areas need to be accurately identified to beneficially optimize the dataset to selectively obtain the second image dataset from the first image dataset. Herein, the method comprises pre-identifying the non-interesting areas i.e., the locations and/or objects that do not match the need and/or out of the scope of implementation. For example, in a powerline maintenance setup, only the area (for example, including a distance of up to 100 m from the powerlines) surrounding the powerlines comprise the area of interest and all the other objects and areas in the environment are considered to be non-interesting areas. This is done so as to segregate the area of interest from the non-interesting areas in the environment, and selectively process data pertaining to only the area of interest at a high resolution. This reduces the data storage space required, data storage costs incurred, data transfer time and processing time.

Further, in some implementations, upon pre-identifying the one or more non-interesting areas, the aerial vehicle is configured to capture a relatively lower resolution image for the non-interesting areas while capturing the plurality of images of the area of interest, to reduce the size of the first image dataset. In an example, while covering a powerline through a forest area or a group of trees, the area of interest being the powerlines and the rest of the forest cover may be treated as the non-interesting area. However, at a different instance, one or more of the trees may be included in the area of interest such as the tree canopies that are high above ground such that they may pose a risk to the powerline upon fall. Beneficially, the capturing of low-resolution images for non-interesting areas is applied to a digital elevation model (DEM) of the environment to reduce the DEM complexity in the non-interesting areas for the given capture and thus to reduce the overall size of the first image dataset. The reduction in overall size of the first image data results in reduced memory storage, memory storage costs, associated computation time and power consumption. The reduced computation time, the reduced memory and power consumption makes the present method faster and efficient. However, it will be appreciated that the area of interest may be varied without limiting the scope of the disclosure. For example, in some cases, the ground may be considered as a non-interesting area, or may be objects shorter than a predefined height (for example, 20 m) are considered non-interesting, or may be only a 100 m buffer around the objects is considered interesting, etc. depending on the implementation. Thus, the DEM complexity optimization by capturing the low-resolution images of non-interesting areas is required to be performed on the DEM before orthorectification.

The method comprises receiving attribute information related to each of the multiple identified objects. Upon identifying each of the multiple objects in the area of interest, the method comprises receiving attribute information related to each of the multiple identified objects. The term “attribute information” refers to the qualitative and/or quantitative characteristic information that may be recorded and/or analysed associated with each of the multiple identified objects. Examples of attribute information include, but is not limited to, location of object, dimensions of object, colour of object, texture of object, type of object, growth rate of object, and so forth. Beneficially, the attribute information allows the method to effectively identify and monitor objects in the area of interest using the captured image data or the first image dataset by providing characteristic information related to the identified objects that may be used to monitor and predict their growth, movement and/or behaviour. It will be appreciated that different types of trees have different growth rate. For example, in a powerlines maintenance setup, upon identifying the nearby objects as a tree, the attribute information allows the method to obtain information regarding the exact type and size of the identified tree and thus, based on available data, the growth of the tree and its branches may be monitored and managed based on the captured image data to ensure that the tree does not come in contact or pose a risk of operation to the powerline.

The method comprises determining if one or more of the multiple identified objects satisfy at least one of a risk criteria based on the attribute information therefor, wherein the risk criteria comprises at least one of selected from: a risk of infiltrating or having potential risk to infiltrate into the area of interest, a risk of posing a hazard to the area of interest. Upon identifying the multiple identified objects, the method comprises determining if one or more of the multiple objects satisfy the risk criteria based on the attribute information. The multiple identified objects are processed based on the attribute information to identify potential risks associated with the identified multiple objects. The risk criteria comprises at least one selected from the risk of infiltrating or having potential risk to infiltrate into the area of interest, the risk of posing a hazard to the area of interest. Typically, the one or more objects are the objects in immediate vicinity to the area of interest that pose either an immediate risk or potential risk at a future instance. In an exemplary scenario, in a powerlines maintenance setup, the area of interest includes the powerlines, whereas the one or more of the identified multiple objects are trees in vicinity to the powerline. Herein, the method utilizes the attribute information of the tree, such as distance of the tree from powerline, dimensions of the tree, type of tree along with existing available data such as the growth rate related to the type of tree to evaluate the potential of the tree to pose a risk of infiltrating or having a potential risk to infiltrate into the area of interest.

It will be appreciated that the above simplified example is only for explanation and other complex implementations shall take place without limiting the scope of the disclosure. In an exemplary scenario, an object such as a tree may be likely to fall onto one or more components of a power distribution infrastructure (such as, the poles and/or the hanging powerlines in the power distribution infrastructure) in proximity of said tree. If any tree falls onto the power distribution infrastructure, it could lead to disruption in delivering electric power and/or could cause fire due to a circuit break. In this regard, it is of critical importance that such risky trees (or objects) are identified and timely removed or trimmed in order to prevent damage and failure of the power distribution infrastructure, for operation of the power distribution infrastructure to be maintained reliably. Pursuant to embodiments of the present disclosure, digitally identifying the risky objects enables efficient management whilst ensuring that operation of the power distribution infrastructure is maintained. This facilitates reduction in cost of vegetation management, better vegetation management planning, and the like.

The method comprises identifying a maximum relevant second area comprising at least the area of interest and each of the one or more of the multiple identified objects satisfying the at least one of risk criteria. Typically, based on the implementation, the area of interest along with the nearby multiple objects that pose a risk or a potential risk of infiltrating the area of interest may be required to be captured and/or processed to effectively monitor and manage the area of interest. In other words, the one or more of the multiple identified objects and their corresponding areas are now considered to be areas of interests and thus the maximum relevant second area (updated or new area of interest) includes both the area of interest and the one or more of the identified multiple objects. To effectively manage the area of interest and ensure a smooth and fault-free operation, the maximum relevant second area is identified to cover each of the potential risky objects and at the same time, eliminates the non-interesting areas (or non-risky objects) from the effective area of interest (i.e. the maximum relevant second area) in order to reduce the memory consumption and computation time for processing the image data and consequently, making the present method faster and efficient.

The method comprises processing the first image dataset to either discard or down-sample areas other than the maximum relevant second area captured therein, to obtain a second image dataset. In an example, the method employs the GNSS data, IMU data, and LiDAR data to determine areas required to be down-sampled or discarded such as areas wherein the image data is captured while the aerial vehicle flies along a tight curve, having high speeds or lying outside the area of interest. Typically, the image data captured under extreme conditions such as tight curves, high speeds, high vibrations (vibrations typically seems to happen when the aerial vehicle takes a hard curve and/or accelerates), high roll/pitch angle (camera pointing to a different location) are considered to be non-interesting or having a bad quality, and thus may be discarded or down-sampled to reduce the size of the image data. Typically, in an implementation scenario, the non-interesting areas i.e., the areas in the environment other than the area encompassed by the maximum relevant second area are either discarded from the first dataset or down-sampled to obtain the second image dataset. For example, the areas in the environment apart from the maximum relevant second area are captured at a lower resolution relative to the captured images in the second image dataset. Beneficially, by processing the first image dataset to either discard or down-sample the non-interesting areas other than the maximum relevant second area captured therein, the overall size of the image dataset to be processed is reduced drastically. Herein, the reduction in the overall size of the dataset results in reduced memory storage costs, associated computation time and power consumption. As a result of the reduced computation time, the reduced memory and power consumption, the present method provides faster and efficient generation of orthorectified image(s).

In an example, such as in cases of a flat terrain or a known flat forest and/or trees, instead of processing each of the pixels in the captured image data (location data for that group of pixels is coming from a digital twin model), a group of pixels based on the attribute information are processed to enable the method to process the image data much faster and efficiently. For instance, consider a whole Digital elevation model (DEM) for an area of 100 m×100 m that is represented by 1000×1000 pixels in the first image dataset. This area may be divided into 4 quadrants, say B1, B2, B3 and B4. In a first example scenario, let us consider that the quadrants B1 and B2 correspond to the area of interest, while the quadrants B3 and B4 correspond to non-interesting areas. In such a case, the image data of the quadrants B1 and B2 may be captured and stored at a high resolution, for example, such as with a pixel size of 0.01 square metres per pixel (that is 0.1 m×0.1 m), while the image data of the quadrants B3 and B4 may be captured and stored at a low resolution, for example, such as with a pixel size of 2500 square metres per pixel (that is 50 m×50 m). In such a case, the height of these pixels is the maximum height of all the real DEM pixels within their respective quadrants. Moreover, down-sampling or discarding the other areas other than the maximum relevant second ares reduces the size of the second image dataset and thus reduces the associated data storage costs and memory consumption to allow for faster processing of said data.

In an embodiment, the method further comprises dividing the second image dataset into two or more second image dataset slices for parallel processing thereof. Typically, in cases of large image data (for example, 50 TB second image dataset), the second image dataset is divided to efficiently and effectively process the entire second image dataset in a faster manner by virtue of the parallel processing thereof. In an example, the second image dataset has a size of 5 TB, wherein the method comprises dividing the second image dataset into five distinct second image dataset slices of 1 TB size each for parallel processing to reduce the computational time by up to 90 percent (For example, in cases of dividing the second image dataset into 10 or more dataset slices). Beneficially, the parallel processing of the two or more second image dataset slices enables a faster processing of the second image dataset and thus reduces the computation time and power consumption.

Optionally, in this regard, the second image dataset is divided into the said two or more second image dataset slices based on at least one of selected from: a predefined time period for capturing an image dataset, a number of available processing threads, an available memory. That is, the division of the second image dataset into the two or more second image dataset slices is done based on a plurality of factors including, but not limited to, the pre-defined time period i.e., the time allocated to the aerial vehicle for capturing the images in the second image dataset, the number of available processing threads, the available memory. Notably, the division is beneficially done in a manner such as to effectively utilize all the available resources (or processing threads) to process the second image dataset quickly and efficiently and thus division of the dataset into more slices than the number of processing thread would be non-beneficial. Thus, depending on the number of available processing threads, the method may vary the number of dataset slices to be divided from the second dataset. Beneficially, to make orthorectification possible and to increase the throughput by parallelization, the pre-aligned second image dataset is split into two or more dataset slices based on HSI timing information and GPS flight trajectory information such that each slice is orthorectifiable. Hence, each slice of the second image data comprises at least the HSI camera model parameters, HSI camera calibration parameters, HSI capture timing data, HSI pixels, GPS location and alignment data, and the DEM that covers the area of interest (or the maximum relevant second area).

Notably, the exact data format depends on the orthorectification algorithm to be applied, wherein the data-splitting or division algorithm takes into account at least the trajectory overlapping and object location(s). Typically, the overlapping data allows the method to select the highest quality of available pixels, and the asset locations allow the method to discard the uninteresting parts during capturing of the image data. Notably, the splitting algorithm parallelization is limited by the available memory, disk and/or network speed, number of processing threads and the desired split size (generally expressed in seconds of capture). Generally, the processing threads for orthorectification pipeline comprises worker units i.e., virtual and/or physical computing devices configured to process the datasets in a parallel manner to maximize throughput by parallelization and data reduction. Beneficially, the selection of the highest quality of available pixels, and the asset locations allow the method to discard the uninteresting parts during capturing of the image data and reduce the overall size of the dataset. Thus, resulting in reduced memory storage costs and faster processing of the dataset.

Optionally, the division of the second image dataset into the dataset slices is performed based on pixel location mapping and at least the set of camera trajectory parts. The dataset slices are formed efficiently, thereby enabling parallelization and ensuring that image data fits into the memory of the processing thread. Further, the size of the dataset slices may be defined automatically, or set by a user running the processing. Generally, the size of the dataset slices is defined in terms of “seconds of flight” (which corresponds to the number of images captured per second by the imaging device (for example, 50 frames per second (fps)). Further, the size of the dataset slice is tuned to the processing thread to create dataset slices such that each processing thread has at least one dataset slice to process. Optionally, the method comprises an automated algorithm configured to check the processing threads and its associated memory and select the number of dataset slices to be created. For example, 16 CPUs or processing threads are configured to manage 1000 dataset slices of the second image dataset. Optionally, the size of the dataset slice may be selected by a user. For example, a user sets the size to X seconds, then all the dataset slices are X seconds long. Optionally, the size of the dataset slice is selected by an automated machine learning algorithm configured to choose or select the dataset slice sizes (such as in, terms of time of flight in seconds), wherein the size of each dataset slice may vary based on the area the trajectory covers. Beneficially, the size of the dataset slice is configured based on the available processing power, memory, number of processing threads and the like, so as to make the processing of the entire dataset faster and more efficient.

For example, in cases of diagonal flights, the diagonal flight covers the maximum area and hence it makes the DEM covering it to grow rapidly. Notably, the two or more second image dataset slices are stored as plans in memory. For example, each dataset slice may comprise X lines of Camera trajectory, (x0, y0, x1, y1) bounding box of the DEM, and camera model as simple text data. Further, the dataset slice may be stored or written as file data on the memory (or hard drive), however, generally to speed up the processing and operation, the disk access is avoided. However, if the prepared second image dataset slices are not pre-written as files, they can be created “on the fly” i.e., while capturing the first image dataset. The method requires only pointers of data in the memory, whereas any external party may require the data to be stored in the memory (or RAM). Optionally, the second image dataset slices are ordered or arranged in an order such that all potentially overlapping datasets are processed at the same time since different parts of the camera trajectory of the aerial vehicle may have captured image data from the same location. Thus, by joining or combining the second image dataset slice, the method or system is enabled to manage the overlapping data on the fly. Optionally, the DEM based on the second image dataset is turned into a 3D model via at least one tinning algorithm.

Notably, the image data such as the first image dataset or the second image dataset are self-contained and separately processable. The processing threads running on real or virtual hardware execute these high level method steps, written as scripts in a programming language, to orthorectify the image data by downloading metadata of the image dataset, test the dataset consistency for errors, form an execution plan to match the infrastructure the processing thread is running on, download relevant data of the dataset, prepare the dataset for orthorectification algorithm, execute the orthorectification algorithm, and upload the orthorectified image dataset to a memory location.

As an example, the aerial vehicle transmits the image data to the data processing arrangement, wherein the image data comprises at least of: the timestamps with location and/or position for each image, sensor arrangement (or model) data, locations of the nearby multiple objects from a digital twin modeling, Digital Elevation Model (DEM) data. Notably, the data optimization in lieu of the aerial vehicle provides a better performance after the first flight image data is recorded, wherein the first flight image data is optimized to enhance the performance of the system during subsequent flights of the aerial vehicle for capturing the image data. During the first flight, if pre-flight image data is not provided by the data processing arrangement, a different resolution public and/or global DEM may be employed having relatively lower resolution of the order of 1 square metre (for example, having a pixel size of 1 m×1 m), 100 square metres (for example, having a pixel size of 10 m×10 m), 2500 square metres (i.e., having a pixel size of 50 m×50 m) and so forth. Hence, a lower quality digital twin to allow rudimentary estimation of the angle of view of imaging device and/or aerial vehicle may be generated. Upon receiving the image data, the aerial vehicle is configured to select the trajectory or path having maximum asset coverage i.e., covering at least the area of interest with variable resolution based on implementation. Typically, the asset coverage is determined by approximating the camera view extent of the aerial vehicle using one or more estimation algorithms including, but not limited to, simple buffering (for example, a distance of 100 m) of trajectory with a buffer size determined based on flight height and camera lens width of the imaging device (of the aerial vehicle), low quality orthorectification for edge pixels by employing simple DEM (such as, flat earth or low-resolution DEM of order 1-10 m). Further, the trajectory data is optimized before capturing the image data by removing potentially “bad” parts of the camera trajectory. In an example, if one or more overlapping trajectory parts are found for a location, the speed, orientation, and lighting conditions are employed to select the image most likely having the best quality or lighting conditions. Notably, each part of the trajectory data is a series of timestamps and related to the location and/or position of each image taken within the time range covered by the timestamps of the part of the trajectory data.

Notably, upon optimizing the image data, the image data is divided into one or more parts for parallel processing to eliminate the existing problem of high memory usage. Typically, the high memory usage of the conventional system and methods is highly dependent upon the manner the orthorectification algorithms are implemented. Conventionally, the entire image data or the whole DEM is loaded into memory as a single unit. Thus, high resolution DEM, like 20-50 cm covering a large trajectory takes up to 50-200 gigabytes of memory. Conventionally to overcome the said problem, low-duration or smaller image data is captured, down-sampling of the entire DEM to reduce memory consumption at a loss of image quality. Upon optimizing and splitting of the image data, a final pixel location map grid may be generated based on at least a user preference or output. Typically, each split of the image data (or the first image dataset) is rasterized at a user selected pixel resolution (for example, 0.2 cm) and provided to an equal number of pixel location mapping algorithm processes. The algorithm provides an output in the form of a map of the size of the DEM data, depicting or indicating the pixel of the raw image data to be orthorectified at the correct location. Optionally, the orthorectification of the image data or of each pixel in the image data is done via a ray-casting algorithm to map the captured pixels to their accurate locations. Herein, the data processing arrangement is further configured to optimize the image data by selectively varying the resolution across different areas of the environment. For example, a low resolution of 50 m×50 m can be used for ground surfaces and a high resolution of 1 m×1 m can be used for tree areas. Optionally, during rasterization of pixels of the image data, the aerial vehicle is configured to monitor and store each of the camera rays associated with each pixel of the image data to enable rasterization of the entire image data. Further, the aerial vehicle is configured to discard pixels low-quality pixels based on at least the speed, angle of view, lighting conditions and so forth.

The present disclosure also relates to the system as described above. Various embodiments and variants disclosed above, with respect to the aforementioned first aspect, apply mutatis mutandis to the system.

Pursuant to embodiments, the data processing arrangement is configured to analyse the first image dataset having the area of interest captured therein to identify the multiple objects in the environment and obtain their associated attribute information to further determine whether any one of the multiple objects pose a risk or not. Such an individual analysis, allows an intricate and precise monitoring of the multiple objects and enables a smooth and efficient operation. Further, upon identifying the risky objects, the data processing arrangement is configured to identify a maximum relevant second area comprising at least the area of interest and each of the one or more of the multiple identified objects satisfying the at least one of risk criteria and process the first image dataset to either discard or down-sample areas other than the defined maximum relevant second area captured therein, to obtain a second image dataset. Thus, the data processing arrangement is configured to reduce the overall size of the dataset to be further processed by discarding or down-sampling the areas other than the maximum relevant second area from the first image dataset to obtain the second image dataset. Beneficially, such a reduction in the overall size of the dataset reduces the associate memory storage costs and computation time for processing the said data, and as a result, the present system saves power, becomes faster, and is cost-efficient at the same time.

Throughout the present disclosure, the term “data processing arrangement” refers to hardware, software, firmware, or a combination of these, for performing specialized data processing tasks of the method. The data processing arrangement is a structure and/or module that includes programmable and/or non-programmable components configured to store, process and/or share information or data. Optionally, the data processing arrangement includes any arrangement of physical or virtual computational entities capable of enhancing information to perform various computational tasks. Further, it will be appreciated that the processing arrangement may be implemented as a hardware processor and/or a plurality of hardware processors operating in parallel or in a distributed architecture. Optionally, the processors in the data processing arrangement are supplemented with additional computation system, such as neural networks, and hierarchical clusters of pseudo-analog variable state machines implementing artificial intelligence algorithms. In an example, the data processing arrangement may include components such as a memory, a processor, a data communication interface, a network adapter and the like, to store, process and/or share information with other computing devices, such as the data source. Optionally, the data processing arrangement includes, but is not limited to, a microprocessor, a microcontroller, a complex instruction set computing (CISC) microprocessor, a reduced instruction set (RISC) microprocessor, a very long instruction word (VLIW) microprocessor, or any other type of processing circuit, for example as aforementioned. Additionally, the data processing arrangement is arranged in various architectures for responding to and processing the instructions for creating training data for an artificial intelligence system to classify hyperspectral data via the system. Optionally, the data processing arrangement comprises a plurality of processors for parallel processing of the two or more second image dataset slices. Optionally, the data processing arrangement is communicably coupled to a data repository wirelessly and/or in a wired manner. Optionally, the data processing arrangement is communicably coupled to the data repository via a data communication network.

It will be appreciated that the data communication network may be wired, wireless, or a combination thereof. Examples of the data communication network may include, but are not limited to, Internet, a local network (such as, a TCP/IP-based network, an Ethernet-based local area network, an Ethernet-based personal area network, a Wi-Fi network, and the like), Wide Area Networks (WANs), Metropolitan Area Networks (MANs), a telecommunication network, a radio network and Worldwide Interoperability for Microwave Access (WiMAx) networks.

Optionally, the data repository is implemented as at least one database server. Optionally, the image data database (including the first image dataset, the second image dataset of the environment) is stored at the data repository. Optionally, the information pertaining to the power distribution infrastructure in the environment is stored at the data repository. Optionally, the data repository stores LiDAR and HSI databases of a plurality of environments, and information pertaining to utility infrastructures in the plurality of environments. Optionally, the data repository is communicably coupled to the unmanned aerial vehicles employed for capturing the first image dataset. Optionally, the data repository is communicably coupled to the unmanned aerial vehicles employed for capturing the information pertaining to the power distribution infrastructure in the environment. Optionally, the data repository is communicably coupled to a device (such as a computer) associated with the power distribution infrastructure. Herein, the term “data repository” refers to an organized body of digital information, regardless of the manner in which the image data or the organized body thereof is represented. Optionally, the data repository may be hardware, software, firmware and/or any combination thereof. For example, the organized body of related image data may be in the form of a table, a map, a grid, a packet, a datagram, a file, a document, a list or in any other form. The data repository includes any data storage software and systems, such as, for example, a relational database like IBM DB2 and Oracle 9. The said data repository is operable to store the image data received from the data sources. Beneficially, the data collected in the data repository is used by the system employing the one or more machine learning algorithms to identify non-interesting areas to down-sample or discard, to reduce the overall size of the image dataset and results in reduced memory consumption and associated storage costs.

In an embodiment, the data processing arrangement is further configured to generate the first image dataset by obtaining one or more parameters to be followed by an aerial vehicle, wherein the one or more parameters comprises at least a path and a speed for the aerial vehicle. Typically, while generating the first image dataset using the aerial vehicle, one or more parameters are defined to be followed by the aerial vehicle to effectively capture the first image dataset. The parameters include at least the path and the speed, however other parameters such as orientation information, air-traffic information, weather information, lighting information and so forth may also be provided to the aerial vehicle. These parameters allow the aerial vehicle to effectively capture the first image dataset comprising the area of interest and enable the aerial vehicle to minimize or eliminate the unusable or unwanted captured data. It will be appreciated that the aerial vehicle may be either an unmanned or a manned aerial vehicle depending upon the implementation without limiting the scope of this disclosure. Further, the data processing arrangement is configured to generate the first image dataset by controlling the aerial vehicle according to the one or more parameters to capture the said image dataset; and discarding a subset of the captured image dataset corresponding to failure of the aerial vehicle to follow the one or more parameters therefor. Typically, the aerial vehicle is configured to follow the defined parameters. For example, the aerial vehicle follows the define path or route at the defined speeds at particular orientation or distance from the area of interest to capturing the first image dataset. Herein, for first flight information of the aerial vehicle, conventional mapping or satellite systems may be employed such as, the United States Geological Survey (USGS) National Map in the United States. However, if the aerial vehicle fails to follow the defined parameters and consequently the subset of the captured image dataset comprising a lower quality image is also captured. In such cases, the subset of the first image dataset is discarded from the first image dataset to eliminate the unnecessary image data and reduce the computational time and effort during orthorectification and/or processing and thus making the system faster and more efficient.

In another embodiment, the data processing arrangement is further configured to generate the first image dataset by controlling an aerial vehicle to capture an image dataset of the area of interest, identifying at least two subsets of the captured image dataset having an overlapped area of the area of interest captured in each of the at least two subsets. Upon generating the image dataset, the data processing arrangement is further configured for identifying the at least two subsets of the image dataset having the overlapped area of interest and selecting one of the at least two subsets for capturing the said overlapped area of the area of interest based on a selection criteria, wherein the selection criteria comprises at least one of selected from: speeds of the aerial vehicle while capturing the at least two subsets, orientations of the aerial vehicle while capturing the at least two subsets, lighting conditions while capturing the at least two subsets. In some cases, such as while capturing image data along the area of interest with different orientations and angles causing overlapping of the captured images in the image dataset, the aerial vehicle tends to capture at least two image datasets of the same object, location and/or overlapped area. And, to eliminate the similar images data from the image dataset, the data processing arrangement is further configured for selecting one of the at least two subsets of the capture image dataset based on the selection criteria. Typically, the at least two subsets are compared to select one of the at least two subsets having better attributes and/or conditions while capturing the image dataset, wherein the comparison is based on at least one of the speed of the aerial vehicle, orientations of the aerial vehicle, lighting conditions, weather conditions and so forth. Thus, beneficially, the data processing arrangement processes only one of the at least two subsets i.e., only the areas that have the best capture conditions, to reduce the associated data storage costs and computation time and make the system faster and efficient.

In an embodiment, the data processing arrangement is configured to identify the at least two subsets based on same geo-coordinates corresponding to capturing of the at least two subsets. Typically, the data processing arrangement is configured to compare each of the captured subsets of the capture image data or the first image dataset with respect to one another based on the geo-location of the capture images provided by the GNSS data, IMU data in the image data to identify the at least two subsets (based on substantially same geo-coordinates). The identified at least two subsets may then be selected based on the selection criteria to select a subset having better attributes and/or conditions similar to the at least two subsets based on the overlapped area from the area of interest. Beneficially, by identifying the at least two subsets based on the sub-substantially same geo-coordinates, the data processing arrangement selects the better quality image of the at least two subsets based on the selection criteria and the lower quality image is discarded to reduce the overall size of the dataset to be orthorectified. Further, the reduction in the overall size of the dataset results in reduced memory storage costs, associated computation time and power consumption. As a result of the reduced computation time, the reduced memory and power consumption, the system becomes faster and more efficient.

In an embodiment, the data processing arrangement is further configured to generate the first image dataset by pre-identifying one or more non-interesting areas of the environment for purposes of generating orthorectified image(s) and capturing relatively lower resolution images of the one or more pre-identified non-interesting areas as compared to the area of interest while capturing a plurality of images of the area of interest. Based on the implementation, the areas of interest changes and thus the corresponding non-interesting areas need to be accurately identified to beneficially optimize the method to capture and orthorectify the first image dataset. Herein, the data processing arrangement is configured to generate the first image dataset by pre-identifying the non-interesting areas i.e., the locations and/or objects that do not match the need and/or out of the scope of implementation. For example, in a powerline maintenance setup, only the area (for example, including a distance of up to 100 m from the powerlines) surrounding the powerlines comprise the area of interest and all the other objects and areas in the environment are considered to be non-interesting areas. Thus, to reduce the size of the first image dataset, upon pre-identifying the one or more non-interesting areas, the aerial vehicle is configured to capture a relatively lower resolution image for the non-interesting areas while capturing the plurality of images of the area of interest. In an example, while covering a powerline through a forest area or a group of trees, the area of interest being the powerlines and the rest of the forest cover may be treated as the non-interesting area. However, at a different instance, one or more of the trees (or risky trees) may be included in the area of interest such as the tree canopies that are high above ground. Beneficially, the capturing of low-resolution images for non-interesting areas is applied to the DEM to reduce the DEM complexity in the non-interesting areas for the given capture and thus to reduce the overall size of the first image dataset. Beneficially, the reduction in the overall size of the first image data results in reduced memory storage costs, computation time and thus saving power. The reduced computation time, the reduced memory and power consumption makes the system faster and more efficient.

In another embodiment, the data processing arrangement is further configured to divide the second image dataset into two or more second image dataset slices for parallel processing thereof. Optionally, the data processing arrangement is configured to divide the second image dataset into the two or more second image dataset slices based on at least one of selected from: a predefined time period for capturing an image dataset, a number of available processing threads, an available memory. That is, the division of the second image dataset into the two or more second image dataset slices is done based on a plurality of factors including, but not limited to, the pre-defined time period i.e., the time allocated to the aerial vehicle for capturing the images in the second image dataset, the number of available processing threads, the available memory. Notably, the division is beneficially done in a manner such as to effectively utilize all the available resources (or processing threads) to process the second image dataset quickly and efficiently and thus division of the dataset into more slices than the number of processing thread would be non-beneficial. Thus, depending on the number of available processing threads, the data processing arrangement may vary the number of dataset slices to be divided from the second dataset. Beneficially, to make the orthorectification possible and to increase the throughput by parallelization, the pre-aligned second image dataset is split into two or more dataset slices based on the provided HSI timing information and GPS flight trajectory information such that each slice is made orthorectifiable. Hence, each slice of the second image data comprises at least the HSI camera model parameters, HSI camera calibration parameters, HSI capture timing data, HSI pixels, GPS location and alignment data, and the DEM that covers the area of interest (or the maximum relevant second area).

Generally, the processing threads of the data processing arrangement is configured for orthorectification pipeline comprising worker units i.e., virtual and/or physical computing devices configured to process the datasets in a parallel manner to maximize throughput by parallelization and data reduction. Beneficially, the selection of the highest quality of available pixels, and the asset locations allow the method to discard the uninteresting parts during capturing of the image data and reduce the overall size of the dataset, thus resulting in reduced memory storage costs and faster processing of the dataset to be orthorectified. Optionally, the preparation of the dataset slices or splits for pixel location mapping based on at least the set of camera trajectory parts, i.e., the dataset slices are formed to enable parallelization and ensure that image data fits into the memory of the processing thread. Further, the size of the dataset slices may be defined automatically, or set by a user running the processing. Generally, the size of the dataset slices is defined in terms of “seconds of flight” (which corresponds to number of images captured per second by the imaging device (for example, 50 frames per second (fps)). Further, the size of the dataset slice is tuned to the processing thread to create dataset slices such that each processing thread has at least one dataset slice to process.

Optionally, the data processing arrangement is configured with an automated algorithm configured to check the processing threads and its associated memory and select the number of dataset slices to be created. For example, 16CPUs or processing threads are configured to manage 1000 dataset slices of the second image dataset. Optionally, the size of the dataset slice may be selected by a user. For example, a user sets the size to X seconds, then all the dataset slices are X seconds long. Optionally, the size of the dataset slice is selected by an automated machine learning algorithm configured to choose or select the dataset slice sizes (such as in, terms of time of flight in seconds), wherein the size of each dataset slice may vary based on the area the trajectory covers. Beneficially, the size of the dataset slice is configured based on available processing power, memory, number of processing threads and the like to make the processing of the entire dataset faster and efficient.

Optionally, the data processing arrangement or the aerial vehicle is configured to transmit the orthorectified second image dataset to a remote location or a cloud storage for processing at a later instance such as when a user requests hyperspectral map data for a specific location and resolution, the system is configured to render the requested image data on the fly.

Typically, the system and/or method for optimizing image data for generating orthorectified image(s) is enabled to remove uninteresting parts of the image data (i.e., locations that do not match user assets), remove low quality parts and/or selecting high quality parts of the captured image data based on the selection criteria. Further, the system and/or method is enabled to pre-calculate the spectral calibrations (moving data from Digital Number (DN) to Radiance) such as from a sensor and converted to an absolute measure of sensor-received-photons at time of capturing image data, whilst at the same time enabled to remove sensor noises if present. Furthermore, the system and/or method is enabled to choose the data type for radiance calibrated data to beneficially match an artificial intelligence (A1) usage at a later stage and to save storage space and system power.

### DETAILED DESCRIPTION OF THE DRAWINGS

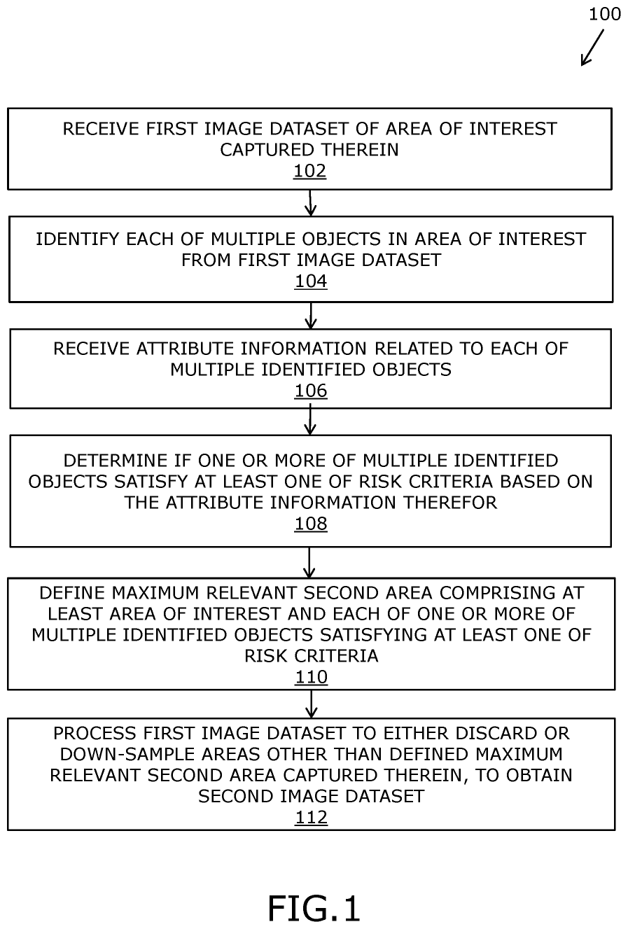

Referring to FIG. 1, illustrated is a flowchart of a method for optimizing image data for generating orthorectified image(s) related to an area of interest in an environment. As shown, the method 100 comprises steps 102, 104, 106, 108, 110 and 112.

At step 102, the method 100 comprises receiving a first image dataset of the area of interest captured therein. Typically, the first image dataset captured by an aerial vehicle is received for further processing to optimize the dataset for generating the orthorectified images.

At step 104, the method 100 comprises identifying each of multiple objects in the area of interest from the first image dataset. The multiple objects in the environment, specially the objects in vicinity to the area of interest, are identified by the method to effectively manage and monitor the area of interest. For example, the number of objects, the location of objects and distance of the objects from the area of interest may be determined via identifying each of the multiple objects.

At step 106, the method 100 comprises receiving attribute information related to each of the multiple identified objects. The attribute information of each of the identified multiple objects allows the method 100 to accurately identify the object (such as the type, size etc.) and based on which the identified objects may be further classified as a risk or not.

At step 108, the method 100 comprises determining if one or more of the multiple identified objects satisfy at least one of a risk criteria based on the attribute information therefor, wherein the risk criteria comprises at least one of selected from: a risk of infiltrating or having potential risk to infiltrate into the area of interest, a risk of posing a hazard to the area of interest. Upon receiving the attribute information, the method 100 determines whether any object of the identified multiple objects satisfy the risk criteria and pose a risk of infiltrating or having potential risk to infiltrate into the area of interest and consequently hinder or affect the operation.

At step 110, the method 100 comprises defining a maximum relevant second area comprising at least the area of interest and each of the one or more of the multiple identified objects satisfying the at least one of risk criteria. Upon identifying the one or more of the multiple identified objects, the method 100 comprises defining the maximum relevant second area (or the updated area of interest) to include the area of interest and the one or more risky objects.

And, at step 112, the method 100 comprises processing the first image dataset to either discard or down-sample areas other than the defined maximum relevant second area captured therein, to obtain a second image dataset. Upon determining the maximum relevant second area, other areas in the environment apart from the defined maximum relevant second area are down-sampled or discarded to optimize the image data for orthorectification.

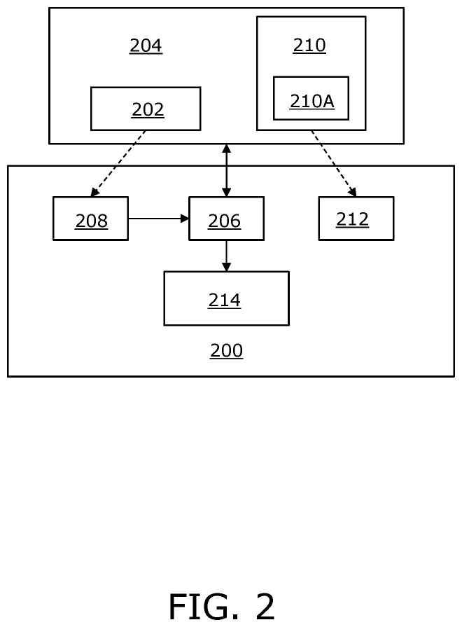

Referring to FIG. 2, illustrated is a block diagram of a system 200 for optimizing image data for generating orthorectified image(s) related to an area of interest 202 in an environment 204, in accordance with an embodiment of the present disclosure. As shown, the system 200 comprises a data processing arrangement 206. The data processing arrangement 206 is configured to receive a first image dataset 208 of the area of interest 202 captured therein, identify each of multiple objects 210 in the environment 204 from the first image dataset 208. Further, the data processing arrangement 206 is configured to receive attribute information 212 related to each of the multiple identified objects 210, determine if one or more of the multiple identified objects 210A satisfy at least one of a risk criteria based on the attribute information 212 therefor, wherein the risk criteria comprises at least one of selected from: a risk of infiltrating or having potential risk to infiltrate into the area of interest 202, a risk of posing a hazard to the area of interest 202, define a maximum relevant second area 214 comprising at least the area of interest 202 and each of the one or more of the multiple identified objects 210A satisfying the at least one of risk criteria; and process the first image dataset 208 to either discard or down-sample areas other than the defined maximum relevant second area 214 captured therein, to obtain a second image dataset 214.

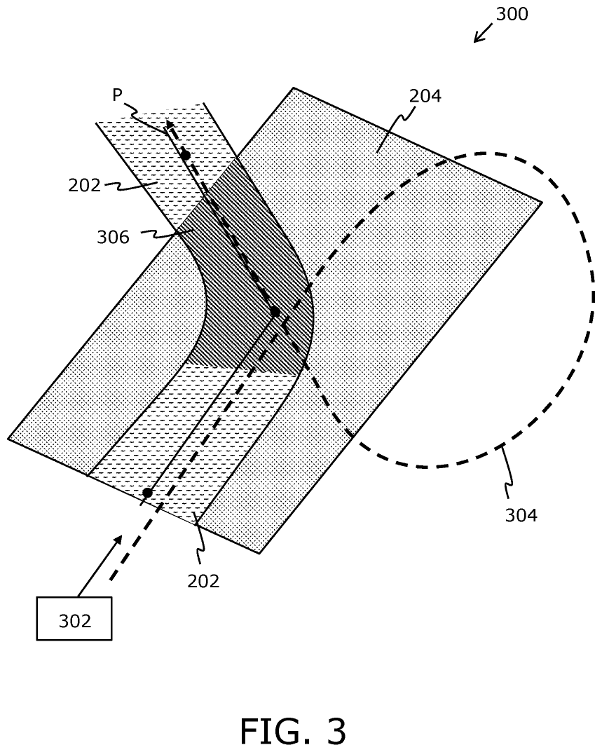

Referring to FIG. 3, illustrated is a diagrammatic illustration of an exemplary working environment 300 of an aerial vehicle 302 for capturing image data for generating orthorectified image(s) related to an area of interest 202 in an environment 204, in accordance with an embodiment of the present disclosure. As shown, the aerial vehicle 302 (shown as a block) is configured to follow a path 304 (shown as a dashed line) for capturing the image data and more specifically, the first image dataset 208. The exemplary working environment 300 is related to a power distribution infrastructure or a powerline maintenance system configured to keep track of powerline P (shown as a solid line) and the nearby objects (or trees) in the environment 204 to ensure smooth and un-interrupted operation of the powerline P. Typically, while capturing the image data related to the area of interest 202, the aerial vehicle 302 is susceptible to capturing similar or exact images of the same location from different orientations and angles of view and thereby increasing the overall size of the dataset. As shown, the aerial vehicle 302 is able to easily capture the area along a straight path of the area of interest 202. However, while taking a sharp turn, the aerial vehicle 302 may have to follow a circular path and consequently ends up capturing non-useful or extra images in an overlapping area 306. Thus, beneficially, the method 100 and/or system 200 discard the captured data related to the overlapping area 306 and are further enabled to control the speeds of the aerial vehicle 302 while capturing the image data, orientations of the aerial vehicle 302 while capturing the image data to optimize or reduce the size of the first image dataset 208 before orthorectification.

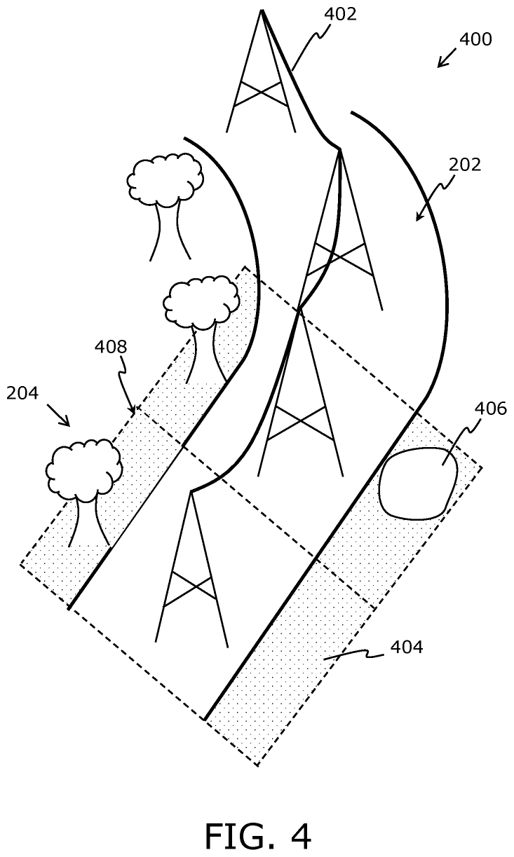

Referring to FIG. 4, illustrated is a diagrammatic illustration 400 of an exemplary environment 204 including a power-distribution infrastructure, in accordance with an embodiment of the present disclosure. As shown, the environment 204 comprises the area of interest 202 including a power-line arrangement 402 (including both the powerline and the pole). Typically, the method 100 and/or the system 200 is employed to determine at least the non-interesting areas in the environment 204, wherein the aerial vehicle 302 (shown in FIG. 3) may capture a lower resolution image to reduce the overall size of the image data captured. Further shown, the environment 204 comprises at least three distinct type of areas to be captured apart from the area of interest 202 covering the power-line arrangement 402. Notably, the at least three distinct areas are a ground surface 404, a water body 406 and a forest area 408. Typically, pursuant to the embodiment of the present disclosure, the aerial vehicle 302 is configured to capture lower resolution or quality image data of the ground surface 404, the water body 406 whereas a relatively higher pixel resolution or quality is used for the forest area 408 (for example, to identify the tree type and structure). Hence, the method 100 and/or the system 200 optimizes the size of the dataset by down-sampling or discarding the area 404, 406 and 408 based on the requirement. For example, the forest area 408 requires a full or at least higher resolution (for example, 512×512 pixels) whereas near the areas 404, 406, wherein only a flat ground and water body is present, the image data size may be optimized for e.g., by using low-resolution imaging such as of the order of 4×4, 8×8, 16×16, 32×32 pixels and so forth.

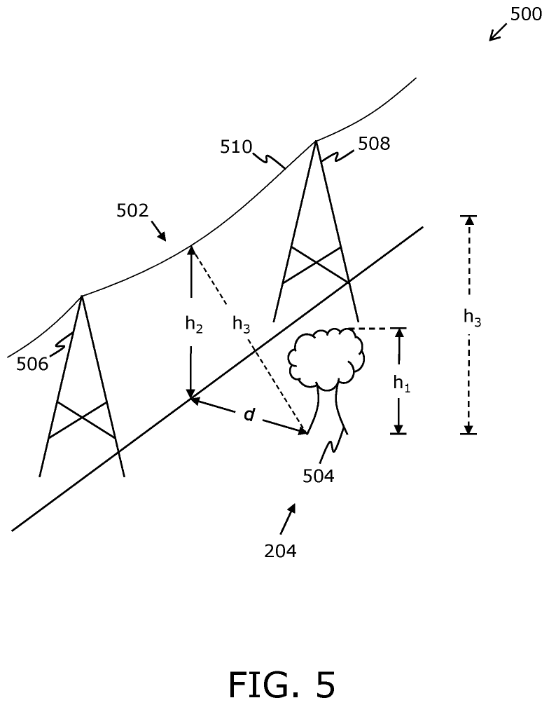

Referring to FIG. 5, illustrated is a diagrammatic illustration 500 of an exemplary environment 204 including a power distribution infrastructure 502 and a tree 504, in accordance with an embodiment of the present disclosure. The power distribution infrastructure 502 comprises a plurality of poles (depicted as poles 506 and 508) and a powerline 510. The environment 204 includes a plurality of trees (or objects). For sake of simplicity, there is shown a single tree 504 from amongst the plurality of trees. The tree 504 is in proximity of the powerline 510. The tree 504 would be identified as a risky tree (or object) or as the one or more of the multiple identified objects upon satisfying at least one of a risk criteria based on the attribute information therefor, wherein the risk criteria comprises at least one of selected from: a risk of infiltrating or having potential risk to infiltrate into the area of interest, a risk of posing a hazard to the area of interest. Specifically, in an example, when a height of the tree 504 is equal to or greater than a Pythagorean sum of a distance d of the tree 504 from the powerline 510 and the height h2 of the powerline in a proximity of the tree 504 and when a current height h1 of the tree 504 does not satisfy the aforesaid risk criteria, the tree 404 is not currently identified as a risky tree. In future, when the tree 504 grows and its height becomes equal to or greater than h3, the tree would be identified as a risky tree as then the height of the tree 504 would be equal to or greater than the Pythagorean sum (as squared (h3) is equal to or greater than a sum of squared (h2) and squared (d)), however optionally, if height of tree h2 is almost equal but lesser than the height h3 (for example, in the margin range of 10 percent), the tree 504 may be identified as a potentially risk tree.

It may be understood by a person skilled in the art that the FIGS. 3, 4 and 5 are merely examples for sake of clarity, which should not unduly limit the scope of the claims herein. The person skilled in the art will recognize many variations, alternatives, and modifications of embodiments of the present disclosure.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for optimizing image data for generating orthorectified image(s) related to an area of interest in an environment, the method comprising:
receiving a first image dataset of the area of interest captured therein;
identifying each of multiple objects in the area of interest from the first image dataset;
receiving attribute information related to each of the multiple identified objects;
determining if one or more of the multiple identified objects satisfy at least one of a risk criteria based on the attribute information therefor, wherein the risk criteria comprises at least one of selected from: a risk of infiltrating or having potential risk to infiltrate into the area of interest, a risk of posing a hazard to the area of interest;
identifying a maximum relevant second area comprising at least the area of interest and each of the one or more of the multiple identified objects satisfying the at least one of risk criteria; and
processing the first image dataset to either discard or down-sample areas other than the maximum relevant second area captured therein, to obtain a second image dataset for performing orthorectification.

2. The method according to claim 1 further comprising generating the first image dataset, wherein generating the first image dataset comprises:
obtaining one or more parameters to be followed by an aerial vehicle, wherein the one or more parameters comprise at least a path and a speed for the aerial vehicle;
controlling the aerial vehicle according to the one or more parameters to capture the said image dataset; and
discarding a subset of the captured image dataset corresponding to failure of the aerial vehicle to follow the one or more parameters therefor.

3. The method according to claim 1, further comprising generating the first image dataset, wherein generating the first image dataset further comprises:
controlling an aerial vehicle to capture an image dataset of the area of interest;
identifying at least two subsets of the captured image dataset having an overlapped area of the area of interest captured in each of the at least two subsets; and
selecting one of the at least two subsets for capturing the said overlapped area of the area of interest based on a selection criteria, wherein the selection criteria comprises at least one of selected from: speeds of the aerial vehicle while capturing the at least two subsets, orientations of the aerial vehicle while capturing the at least two subsets, lighting conditions while capturing the at least two subsets.

4. The method according to claim 3, further comprising identifying the at least two subsets based on same geo-coordinates corresponding to capturing of the at least two subsets.

5. The method according to claim 1, further comprising generating the first image dataset, wherein generating the first image dataset further comprises:
pre-identifying one or more non-interesting areas of the environment for generating orthorectified image(s); and
capturing relatively lower resolution images of the one or more pre-identified non-interesting areas as compared to the area of interest while capturing a plurality of images of the area of interest.

6. The method according to claim 1 further comprising dividing the second image dataset into two or more second image dataset slices for parallel processing thereof.

7. The method according to claim 6, wherein the second image dataset is divided into the said two or more second image dataset slices based on at least one of selected from: a predefined time period for capturing an image dataset, a number of available processing threads, an available memory.

8. The method according to claim 1, wherein the image data comprises at least one of selected from: Light Detection and Ranging (LiDAR) data, hyperspectral imaging data, Global Navigation System Satellite (GNSS) data, Inertial Measurement Unit (IMU) data.

9. A system for optimizing image data for generating orthorectified image(s) related to an area of interest in an environment, the system comprising a data processing arrangement, wherein the data processing arrangement is configured to:
receive a first image dataset of the area of interest captured therein;
identify each of multiple objects in the area of interest from the first image dataset;
receive attribute information related to each of the multiple identified objects;
determine if one or more of the multiple identified objects satisfy at least one of a risk criteria based on the attribute information therefor, wherein the risk criteria comprises at least one of selected from: a risk of infiltrating or having potential risk to infiltrate into the area of interest, a risk of posing a hazard to the area of interest;
identify a maximum relevant second area comprising at least the area of interest and each of the one or more of the multiple identified objects satisfying the at least one of risk criteria; and
process the first image dataset to either discard or down-sample areas other than the maximum relevant second area captured therein, to obtain a second image dataset for performing orthorectification.

10. The system according to claim 9, wherein the data processing arrangement is further configured to generate the first image dataset by:
obtaining one or more parameters to be followed by an aerial vehicle wherein the one or more parameters comprise at least a path and a speed for the aerial vehicle;
controlling the aerial vehicle according to the one or more parameters to capture the said image dataset; and
discarding a subset of the captured image dataset corresponding to failure of the aerial vehicle to follow the one or more parameters therefor.

11. The system according to claim 9, wherein the data processing arrangement is further configured to generate the first image dataset by:
controlling an aerial vehicle to capture an image dataset of the area of interest;
identifying at least two subsets of the captured image dataset having an overlapped area the area of interest captured in each of the at least two subsets; and
selecting one of the at least two subsets for capturing the said overlapped area of the area of interest based on a selection criteria, wherein the selection criteria comprises at least one of selected from: speeds of the aerial vehicle while capturing the at least two subsets, orientations of the aerial vehicle while capturing the at least two subsets, lighting conditions while capturing the at least two subsets.

12. The system according to claim 11, wherein the data processing arrangement is configured to identify the at least two subsets based on same geo-coordinates corresponding to capturing of the at least two subsets.

13. The system according to claim 9, wherein the data processing arrangement is further configured to generate the first image dataset by:
pre-identifying one or more non-interesting areas of the environment for generating orthorectified image(s); and
capturing relatively lower resolution images of the one or more pre-identified non-interesting areas as compared to the area of interest while capturing a plurality of images of the area of interest.

14. The system according to claim 9, wherein the data processing arrangement is further configured to divide the second image dataset into two or more second image dataset slices for parallel processing thereof.

15. The system according to claim 14, wherein the second image dataset is divided into the said two or more second image dataset slices based on at least one of selected from: a predefined time period for capturing an image dataset, a number of available processing threads, an available memory.

16. The system according to claim 9, wherein the image data comprises at least one of selected from: Light Detection and Ranging (LiDAR) data, hyperspectral imaging data, GNSS data, IMU data.
